(19) United States
(12) Patent Application Publication
(10) Pub. No.: US 2023/0193739 A1
(43) Pub. Date: Jun. 22, 2023

(54) COMPUTERIZED METHOD FOR PERFORMING WORK-FLOW DRILLING OPERATION MANAGEMENT FOR OFFSHORE DRILLING OPERATIONS

(71) Applicant: Horizon56 A/S, Kongens Lyngby (DK)

(72) Inventors: Esben Ehrenreich Thorup, Kongens Lyngby (DK); Craig Michael Reid, Kongens Lyngby (DK)

(73) Assignee: Horizon56 A/S, Kongens Lyngby (DK)

(21) Appl. No.: 18/068,679

(22) Filed: Dec. 20, 2022

Related U.S. Application Data
(60) Provisional application No. 63/292,635, filed on Dec. 22, 2021.

(51) Int. Cl. E21B 44/00; G06Q 50/02; G06Q 10/0631

(52) U.S. Cl. CPC E21B 44/00; G06Q 50/02; G06Q 10/063114

(57) ABSTRACT

A computerized method for performing work-flow drilling operation management for offshore drilling operations. In a planning phase, the planner creates digital work instructions in the software tool and shares these digital work instructions for the offshore drilling operations with one or more reviewers for approval. In an operation phase, an approved version of the digital work instructions is created and shared with a plurality of drilling rig operators. The plurality of drilling rig operators performs the offshore drilling operations, and to report progress of the offshore drilling operations according to the approved version of the digital work instructions. By means of the software tool a progress report is created.

### FIELD

The present invention relates to a computerized method for performing work-flow drilling operation management for offshore drilling operations involving a software tool, a planner, one or more reviewers, and a plurality of drilling rig operators, and to a computer program product configured to implement the method.

### BACKGROUND

Recent advances in drilling techniques have delivered new levels of operational efficiency. Oil producing companies strive for even higher levels of drilling performance, with many requesting drilling contractors supply higher levels of automation on their rigs. In this market, drilling companies focus on delivering operational efficiencies, predictability, consistent results aligned with standard operational procedures and performance standards, and increased safety.

Providing offshore drilling services from a rig or vessel operating in an offshore, harsh environment is very complex. Planning the drilling operation based on some knowledge and coordinating activities together with the customer and one or more subcontractors is very complex and requires high coordination between involves parties. As new knowledge is gained while drilling, the plan of activities must be very adaptive, which complicates the decision making.

### SUMMARY

The purpose of the invention is to provide a method for performing work-flow drilling operation management for offshore drilling operations.

According to the first aspect of the invention there is provided a computerized method for performing work-flow drilling operation management for offshore drilling operations involving a software tool, a planner, one or more reviewers, and a plurality of drilling rig operators. A planning phase includes creating, by the planner, digital work instructions for the offshore drilling operations in the software tool, and sharing, via the software tool, the digital work instructions as draft digital work instructions for the offshore drilling operations with one or more reviewers for approval. An operation phase includes creating, in the software tool, an approved version of the digital work instructions when approved by the one or more reviewers, sharing, via the software tool, the approved version of the digital work instructions with a plurality of drilling rig operators, wherein the plurality of drilling rig operators performs the offshore drilling operations according to the approved version of the digital work instructions, and reporting, by the drilling rig operators via the software tool, progress of the offshore drilling operations according to the approved version of the digital work instructions. The software tool is configured to create a progress report, whereby the planner, the one or more reviewers, and the plurality of drilling rig operators may inspect progress in the work-flow drilling operations relatively to the approved version of the digital work instructions.

Optionally, the software tool is in the planning phase configured to invite the planner to specify sensor input offshore drilling operations to be presented in the progress report.

Optionally, the software tool is in the planning phase configured to permit the one or more reviewers to request changes of the draft digital work instructions prior to approval.

Optionally, the software tool is at the completion of the operation phase configured to automatically create a report based on data collected from the digital work instructions and the reported progress.

Optionally, the software tool is in the planning phase configured to invite the planner to specify sensor input offshore drilling operations to be presented in the progress report, and wherein the report also include the reported sensor data.

Optionally, the software tool is during the operation phase is configured to presenting a part the progress report to drilling rig operators on a monitor on the vessel.

According to the further aspect of the invention there is provided non-transitory computer-readable medium storing instructions that when executed by a processor cause the processor to perform work-flow drilling operation management for offshore drilling operations involving a planner, one or more reviewers, and a plurality of drilling rig operators. A planning phase includes creating digital work instructions for the offshore drilling operations and sharing the digital work instructions as draft digital work instructions for the offshore drilling operations with one or more reviewers for approval. An operation phase includes creating an approved version of the digital work instructions, sharing the approved version of the digital work instructions with a plurality of drilling rig operators, wherein the plurality of drilling rig operators performs the offshore drilling operations according to the approved version of the digital work instructions, and reporting progress of the offshore drilling operations according to the approved version of the digital work instructions. The software tool creates a progress report available to the planner, the one or more reviewers, and the plurality of drilling rig operators may inspect progress in the work-flow drilling operations relatively to the approved version of the digital work instructions.

Optionally, the computer program product is configured to, upon completion of the operation phase, automatically create a report based on data collected from the digital work instructions and the reported progress.

Optionally, the computer program product is configured to, in the planning phase, to invite the planner to specify sensor input offshore drilling operations to be presented in the progress report, and to include the reported sensor data into the report.

Various other aspects and further examples are also described in the following detailed description and in the attached claims with reference to the accompanying drawings, in which:

### BRIEF DESCRIPTION OF THE DRAWINGS

FIG. 1 illustrates schematically a floating vessel performing a drilling or maintenance operation according to one embodiment of the invention;

FIG. 2 illustrates stakeholders involved in a planning phase and an execution phase of the drilling operation;

FIG. 3 illustrates a computerized method for performing work-flow drilling operation management for offshore drilling operations according to the invention;

FIG. 4 shows one embodiment for the data network present on the drilling vessel for implementing the invention;

FIG. 5 illustrates a feedback loop wherein the planner collects knowledge and based on his experience creates digital work instructions;

FIG. 6 illustrates schematically a Hydrocarbon Production Well with Multiple Casing Strings drilled by means of the method according to the invention;

FIG. 7 illustrates drilling operation windows when performing offshore drilling; and

FIG. 8 illustrates well plan operations, and the decisions taking.

### DETAILED DESCRIPTION OF THE DRAWINGS

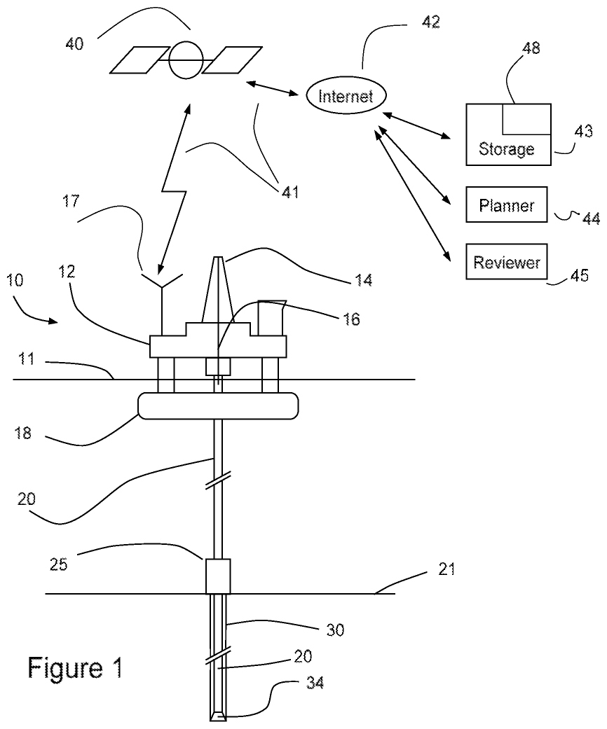

FIG. 1 illustrates schematically a floating vessel 10 performing a drilling or maintenance operation according to one embodiment of the invention. The vessel 10 is in the illustrated embodiment a so-called semi-sub. The vessel 10 is floating on the surface 11 of the sea and has a hull 12 carrying a derrick 14 and a drill deck defining one or more well centres 16. The vessel 10 has at least two submerged, ballasted, watertight pontoons 18.

The drilling operation is operated from the well centre 16, from where a tubular, such as a drill string 20, extends via a well head assembly 25 on the drill floor 21 and further down to a subsea well 30. While passing through the sea, the drilling string will normally be contained in a riser structure. In the well 30, the drill string 20 rotates the bottom hole assembly (BHA) or the drill bit 34. The drill string 20 comprises of a plurality of tubulars. Tubular running refers to a generic process of handling tubulars on a rig, lowering tubulars to the well and installing casing accessories. Tubulars are stocked up on the rig (and replenished as required) prior to being run into the well.

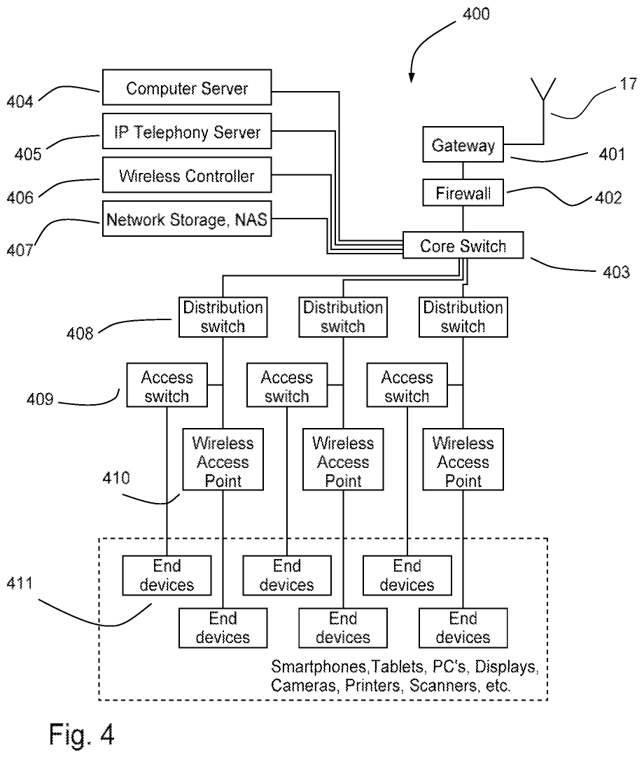

The vessel 10 has a data network 400 (FIG. 4). The equipment on the vessel 10 is heavily equipped with sensors 47 as mechanical equipment is turned into connected sensors. The vessel 10 may have several thousand sensors 47 onboard, all helping platform operators make smarter decisions about equipment utilisation and enabling predictive maintenance.

The operator of the vessel 10 uses sensors 47 etc. to understand the ongoing operations and equipment performance, and to assist the offshore maintenance engineers do their work from distanced onshore locations.

As the vessel 10 may operate far from cellular network coverage, the data network 400 is in one embodiment connected to the Internet 42 via a satellite link 41. For this purpose, the vessel 10 is equipped with an antenna 17 having a transceiver for establishing the radio interface between the data network 400 and a satellite 40. In on embodiment, the antenna 17 is a parabolic antenna configured to provide sufficient gain and directivity for establishing a reliable satellite link 41. According to the invention the satellite link 41 will have permanent character as long as the drilling operation is ongoing. Hereby, the satellite link 41 ensures a reliable communication link between the data network 400 covering the vessel 10 and remote computers, such as the storage 43, which may be a cloud-based storage, the computer of the planner 44, which may be operating in a Local Area Network of the company being responsible for planning the drilling operation, and the computer of the reviewer 45. Both the planner 44 and the reviewer 45 will normally operate from land (onshore) but both may visit the vessel as guest and use the data network 400 as guests.

A software tool 48 is according to the invention stored in the storage 43. The software tool 48 provides a template for the work-flow drilling operation management for offshore drilling operations according to the invention. Depending on the access rights granted, the planner 44, the one or more reviewers 45, and the plurality of drilling rig operators 46 may via respective software application access instructions in the work-flow drilling operation, report completion of individual steps and monitor progress.

FIG. 4 shows one embodiment for the data network 400 present on the drilling vessel 10 for implementing the invention. The data network 400 has a gateway 401 allowing data to pass between the data network 400 and the Internet 42 via the antenna 17. The gateway 401 is configured communicate by using one or more appropriate telecommunication protocols for connecting the data network 400 to the Internet 42. The gateway 401 can operate at any of the seven layers of the open systems interconnection model (OSI). The gateway 401 operates in one embodiment as a network gateway providing interoperability between remote networks and comprises elements for protocol translation, impedance matching, rate conversion, fault isolating, or signal translation. When gateway 401 operates as a network gateway, it usually also acts as a proxy server and a firewall. However, in FIG. 4 the firewall 402 of the data network 400 is shown as a separate unit. The firewall 402 is configured to monitor and control incoming and outgoing network traffic based on predetermined security rules. The firewall 402 establishes a barrier between the data network 400 and the Internet 42.

In some embodiments, the data network 400 operates with managed switches for managing, configuring, and monitoring the network. The managed switches provide greater control over how data travels over the network and who can access that data.

A core switch 403 with high capacity is positioned within the backbone or physical core of a network 400. The core switch 403 controls the data traffic through the gateway 401 between the data network 400 and the Internet 42. The core switch 403 provides a final aggregation point for the data network 400 and allow multiple aggregation modules to work together. A computer server 404 is programmed and configured to control the core switch 403 according to the set of programmed rules.

In embodiments, where the network 400 has more than one outgoing communication path, additional core switches 403 may be provided.

In some embodiments, an IP telephony server 405 is connected to the core switch 403 and is configured to manage IP telephony inside the data network 400, and to and from the data network 400 via the gateway 401. The IP telephony server 405 allows individuals on the vessel 10 to communicate electronically using their smartphones, tablets or computers, all named as end devices 411.

In some embodiments, a wireless controller 406, or WLAN controller, monitors and manages wireless access points in the data network 400 and allows wireless devices (smartphones, tablets or computers, all named as end devices 411) to connect to a wireless network architecture, such as WLAN.

In some embodiments, the data network 400 comprises a computer data storage server 407, such as a Network-Attached Storage (NAS). A NAS may be manufactured as a computer appliance—a purpose-built specialized computer.

As mentioned above, the core switch 403 provides a final aggregation point for the data network 400 and allow a plurality of aggregation modules to work together. The aggregation modules each comprises a distribution switch 408 and are configured to provide data access to various entities on the vessel 10, and these entities may include the accommodation, the control room, and the drill string monitoring sensors 47. The distribution switch 408 in the aggregation module is terminated in one or more access switches 409 providing a wired data connection for one or more end devices 411, and/or one or more wireless access points 410 providing wireless data connection for one or more end devices 411.

The sensor 47 will in some embodiments be an end device 411 delivering sensor data 207 to the data network 400 via the one or more access switches 409 and in some cases also via the one or more wireless access points 410.

The end devices 411 may include a variety of personal user devices like smartphones, tablets and PC's, but also some purpose specific devices like displays/monitors, surveillance cameras, printers, scanners, IP conference tools, IP telephones, etc.

According to the invention, there is provided a computerized method for performing work-flow drilling operation management for offshore drilling operations involving a planner, one or more reviewers, and a plurality of drilling rig operators. The work-flow drilling operation are according to the invention managed in a web-based collaborative platform involving document management and storage.

In one embodiment of the invention, the web-based collaborative platform is configured as a software application meaning that the web-based collaborative platform is run like an app on the computer, smartphone, or tablet. In some embodiments, the web-based collaborative platform may be accessed via a browser presenting progress of the drilling operation on a monitor.

Access to the web-based collaborative platform requires a reliable authentication of the individual users, e.g. by means of credentials or by use of a token, e.g. an ID card with RFID, or a combination of both. This enables a unique identification of the individual contributors to the digital work instructions regardless of the contribution has been planning a work step, approving the planned work step, or confirming that the work step has completed. This unique identification also includes time stamps for individual contributions. All the individual contributors may request adjustment when observing potential issues and the planner may update the plans accordingly. The reviewers may approve the updated plans. Hereby the digital work instructions become a dynamical web-based collaborative platform where the amendment history is collected. Also the completion history for the individual work steps is included. In some embodiments, sensor data 207 from a selection of the sensors 47 of the drilling vessel 10 is part of the data recorded with the digital work instructions, either as tables or graphs. Once the drilling has been completed, software application tool may generate a complete report based on the document history and all the data inputted during the campaign.

Offshore drilling involves a significant team of specialists where the operator, drilling contractor and multiple service companies must work together toward a single goal.

The major drivers are safety, price, efficiency, and predictability. Drilling automation needs to align with the goals of not just the rig contractor but also the operator if it is to improve overall performance. Therefore, the operator or customer going to produce oil from the drilled well is heavily involved in the planning and execution phase, where the drilling operation plan is drafted, approved, dynamically adjusted and completed, partly by reviewing the plan and later updates, partly as the achievements are visibly and transparent.

This system is based in the fundamental well construction process—a planner, often from the drilling contractor, plans a well, then the drilling operator/customer and various service companies recommends adjustments, and drilling contractor and the service companies drill the well according to that plan. Operational results are recorded, and all parties learns from the results obtained. Those learnings are then fed into later wells to be drilled, and the process is repeated.

If the digital work instructions during the operation phase need to be updated due to a delay, the need for changing casing size, the need for amending cement composition, observation of kick indicators or the like, the planner 44 updates the digital work instructions, asks for approval from reviewers 45, and shares the updated digital work instructions 205 to the drilling rig operators 46 and reviewers 45.

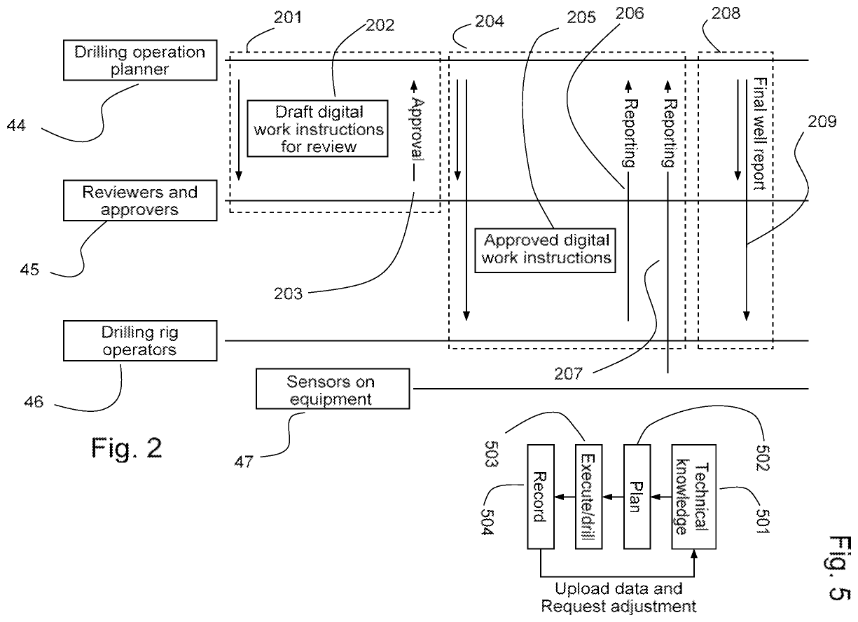

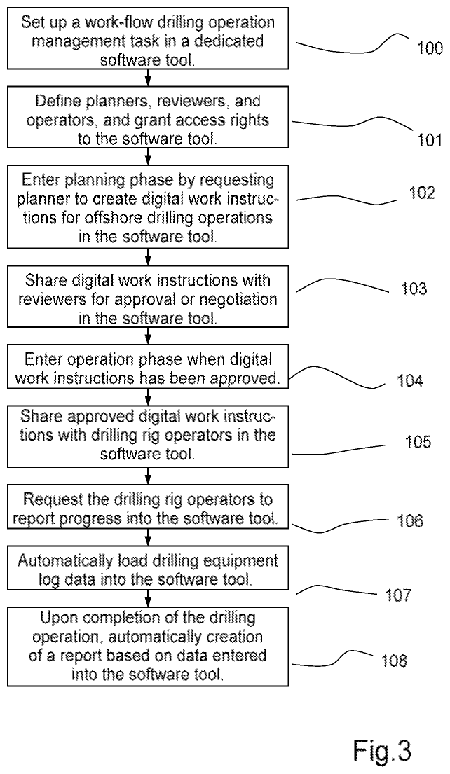

FIG. 3 illustrates a computerized method for performing work-flow drilling operation management for offshore drilling operations according to the invention. FIG. 2 illustrates stakeholders involved in a planning phase 201 of the drilling operation, an execution phase 204 of the drilling operation, and in a reporting phase 208 for the completion of the drilling operation.

Prior to the start of a drilling campaign, the drilling company in charge of the drilling operation allocates a planner for organizing the campaign. In step 100, the stakeholders involved in the planning phase 201 and the execution phase 204 are identified. These stakeholders may involve a planner (from the drilling company), one or more reviewers (from the customer who later on has to operate the well and from various subcontractors), and a plurality of drilling rig operators (performing various task on the drilling vessel 10). Some shall be able to approve or review the drilling operation plan and challenge its elements. These are in the software application tool according to the invention identified as reviewers (authorizers) of the drilling operation plan. These may include the customer planning to operate the oil or gas well once completed. Also, subcontractors being responsible for certain part of the drilling operation plan will have a status as reviewers. These subcontractors may be responsible to the cementing procedure, mud circulation, operation of a ROV and the like. The planner is responsible for the shareholder reviews the drilling operation plan prior to the start of the campaign, and for negotiating amendments and approve these during the campaign. These amendments may be caused by delays, downtime or faster execution than expected. The reviewers will often represent various companies involved in the planning of the drilling operation plan, and they will often be based onshore. In some situations, the drilling rig operators may also comment the drilling operation plan, but they will normally not have to approve the drilling operation plan. The drilling rig operators will often represent various companies involved in the execution of the drilling operation plan, and they will often be based offshore as rig crew.

The drilling operation planner 44 has prior to the drilling campaign collected available data and created upon request. These data may include geological information, like pore-pressure analysis and fracture prediction, for the targeted oil reservoir. Based on these data, the planner may design the pipe setting depth, the hole-geometry, the completion planning, the mud planning, the cement planning. The planner may choose the bit program for the individual drilling stages. Also casings, tubings and drill strings for the individual drilling stages are chosen/designed for fulfilling the purpose. Also, the chosen drilling rig is taken into consideration. Once the desired design for the well construction is in place, the planner uses his engineering skills, experience and backup team in his organisation to create a set of draft digital work instructions 202 for review. The digital work instructions define a set-subtasks required for reaching a well construction.

The drilling operation planner 44 sets up a work-flow drilling operation management task in the dedicated software tool 48 in step 100, and the drilling operation planner 44 defines planners, reviewers, and operators, and ensures that access rights to the software tool 48 is granted in step 101.

In step 102, the drilling operation planner 44 enters the planning phase 201. The software tool 48 requests the planner to create digital work instructions for the offshore drilling operations.

The digital work instructions 202 are in the planning phase 201 shared in step 103, via the software application, as draft digital work instructions for the offshore drilling operations with one or more reviewers 45. The one or more reviewers 45 may, via the software application, request changes of or approve 203 the draft digital work instructions 202.

Once approved in step 104, the operation phase 204 is entered in step 105. An approved version of the digital work instructions 205 is created in the software application. The approved version of the digital work instructions 205 is shared via the software application with the drilling rig operators on the vessel 10. Here the drilling rig operators 46 may inspect on personal end devices 411 (smartphone, tablet, PC or monitor), the tasks given to them and how these tasks depend on or interfere with other ongoing tasks. Once part of the individual task has been performed, the drilling rig operators 46 is requested to report progress 206 into the software tool 48 in step 106. At the same time in step 107, the software tool 48, continuously, with regular intervals, triggered by milestones or events, taps data 207 from a set of predefined sensors 47 coupled to the drilling equipment. The tapped or reported sensor data 207 is stored together with the digital work instructions 205 and the reported progress 206 in the storage 43 and real time available for the planner 44, the reviewers 45 and the drilling rig operators on the vessel 10.

In step 108, upon completion of the operation phase 204, the software tool 48, in reporting phase 208, automatically creates a final report 209 based on data collected in the storage 43 from the digital work instructions 205 and the reported progress 206. In some embodiments, the report will also include the reported sensor data 207.

FIG. 5 illustrates a feedback loop wherein the planner 44 collects knowledge in step 501 and based on his experience creates digital work instructions 205 in step 502. Once approved, the well is drilled in step 503 based on the digital work instructions 205 by the operators 46 operating the drilling equipment on the drilling vessel 10. Progress is reported in step 504, and reported back to onshore, in order to keep the digital work instructions 205 updated. Hereby all stakeholders can track progress and time plan.

Referring to FIG. 8, an example of well plan operations is discussed, and some of the decisions taken is mentioned. Weight on bit (WOB) is the amount of downward force exerted on the drill bit 34 and is normally measured in thousands of pounds. Gravity acts on the large mass of the collars 810 in the lower part of the drill string 20 to provide the downward force needed for the bit 34 to efficiently break rock. A plurality of downhole Measurement While Drilling (MWD) sensors 47 can measure weight-on-bit more accurately and transmit the data to the surface. The drilling operation planner 44 defines in his digital work instructions, the diameter and type of the drill bit 34. Based on knowledge about the expected geology, the drilling operation planner 44 specifies an operational weight on bit range.

When drilling in deep bores, torque occurs in the drill string 20. As this represents mechanical stress in the drill string 20, reducing the torque is desired and the torque is measured with downhole Measurement While Drilling (MWD) sensors 47.

A kick is a well control problem in which the pressure found within the drilled rock is higher than the mud hydrostatic pressure acting on the borehole or rock face. Such a greater formation pressure may force formation fluids into the wellbore and may in worst case lead to a blowout.

The mud circulation may provide warning signs to the surface. By monitoring the mud circulation by appropriate sensors 47, it is possible to detect an increased flow rate, and an increased pit volume. By placing sensors 47 on the pumps, changes in the mud flow may be detected.

The vessel 10 use a significant number of sensors and the planner 44 defines which sensor data 207 that should be included in the recording into to the software tool 48.

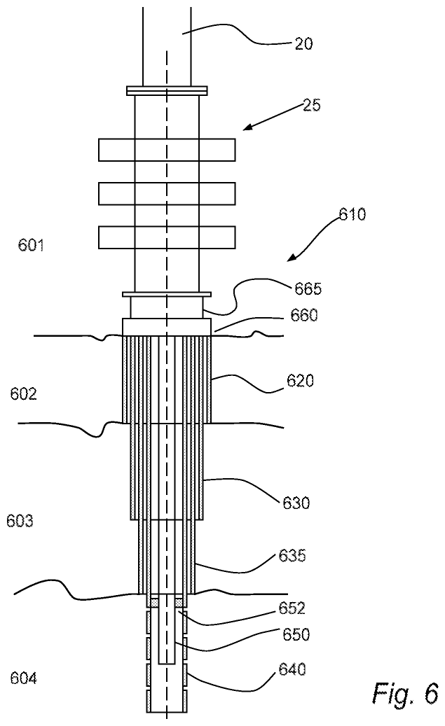

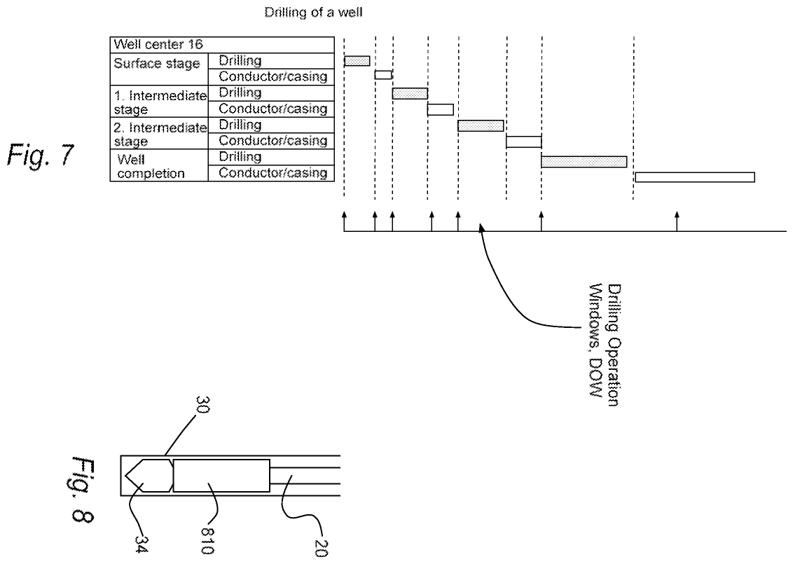

FIG. 6 illustrates the complexity of a well-known drilling process for building a well bore for oil or gas production. Exploration geologists generates an exploration well prospect, and development geologists creates plans for development well locations and objectives. In collaboration with the geologists, drilling engineers develop some detailed drilling plans taking safety, environmental, and regulatory requirements into account. Additional geological surveils may be carried out to identify the locations of potential shallow gas hazards.

Offshore drilling takes place at water depths range typically up to approximately 120 meters for jack-up rigs and up to approximately 3,000 meters for semisubmersibles and drill ships. Drilling a single well may take from 2 weeks up to 12 months depending on the complexity of the project. Progress is reported as sensor data 207.

A conduit (also known as a riser or a conductor) made from sections of steel pipe permits drilling fluids to move between the rig and a well head 660.

The drill string 20 used for drilling the well includes a plurality of connected slender steel pipes and other tools used for the drilling. At the bottom of the drill string 20, there is a hole-boring device called a drill bit 34, and drill collars 810, being heavy sections of pipe, are used for adding weight and stability to the drill bit 34.

While the drilling proceeds, the drilling crew adds new sections of drill pipe to the ever-lengthening drill string. Hydraulic devices keep constant tension on the drill string to prevent the motion of the rig and conductor from being transmitted to the drill bit 34.

The drill string is lowered through the conductor through a well head assembly 25 comprising a stack of safety valves (blowout preventer (BOP)) designed to contain natural high pressures encountered while drilling through the geological formations.

The well head assembly 25 provides a suspension point for the drill string and pressure seals for casing strings in the well bore. The well head 660, on which the well head assembly 25 is mounted, may be welded onto the first string of casing, which has been cemented in place during drilling operations, to form an integral structure of the well.

In a first drilling sequence, a large diameter hole capable of accommodating the first string of casing (surface casing) is drilled. In one embodiment, the surface casing 620 may have a diameter in the range from 40 to 100 cm (18-40 inches). The first section of the well to be drilled is the section going down to the pre-determined surface casing depth. The dimensions are part of the digital work instructions in the well plan.

The surface casing 620 does typically pass through the loose sediments and loose rocks to the bed rock. The objective of the surface casing 620 is to isolate the wellbore from the seabed to ensure that loose debris or sediments does not enter the well during early drilling operations.

When the surface casing point is reached, the surface casing 20 is run into the wellbore and cemented into place. First, the drill pipe is removed from the wellbore during cementing operations. Then, the surface casing 620 is lowed into the well bore and cement slurry is pumped down into the interior of the surface casing 620. The cement is forced, with drilling fluid, up into the annular space between the casing string and the wellbore, and the cement is allowing time to cure (harden).

The cementing of the surface casing 620 serves several purposes. The surface casing 620 act as a barrier separating liquids inside the casing from water outside the casing and prohibits the fluids mixing up. The barrier also protects the well from shallow gas hazards. The blowout preventer being part of the well head assembly 25 may then be installed on top of the surface casing 620.

This drilling process then is continued to the next pre-determined casing point. The selection of these intermediate casing points is coming from the digital work instructions in the detailed drilling plan mentioned earlier. As the drilling string, drilling tools and intermediate casing 630 must pass through the spacing provided by the surface casing 620, it is obvious that intermediate casing 630 has an outer diameter being smaller than the inner diameter of the surface casing 620. The purpose intermediate casing 630 is to act as a barrier and to isolate the interior of the casing against over-pressured zones behind the barrier (prevent a kick) and to protect against unstable geological sections outside the barrier.

The process is repeated for each of the planned casing points. Successive casing strings are run and cemented into place, and smaller diameter tools and drill bit 34 must be used for the continued drilling operations.

During the drilling, the driller/person in charge may maximize the drilling speed or the Rate of Penetration (ROP) of the drill bit 34 by controlling drilling parameters like the weight-on-bit and the rotational speed of the rotary system. The operation is controlled by the digital work instructions in the detailed drilling plan.

Once the final intermediate casing 630 string is run and cemented, the drilling process is continued until the well reaches the Total Depth (TD) of the well. One or more production casing-strings 640 or liners may be applied to reach the Total Depth. The production casing string 640 is extending into the oil and gas reservoir. The production casing string 640 or production liner is used in the completion, and the production casing string 640 is run and cemented. The production casing string has perforations allowing fluids from the oil and gas reservoir to collected in a production tubing 650. The design is according to the digital work instructions in the detailed drilling plan.

FIG. 6 shows the architecture of the well bore 30 and well head 660. The surface casing 620 seals the bore in a layer with sediments and loose rocks in a layer 602 between the seabed and the bedrock 603. Two intermediate casings 630 and 635 act as barriers and to isolate the interior of the casing against over-pressured zones and unstable geological sections outside the intermediate casings 630 and 365. The production casing string 640 is extending into the oil and gas reservoir. The oil and gas reservoir is a subsurface pool of hydrocarbons contained in porous or fractured rock formations. Inside the production casing string 640, the production tubing 650 brings pressurized hydrocarbons to a production rig for further handling. A production packer 652 is used to isolate a section of a borehole to prevent hydrocarbons to escape the production casing string 640.

The seabed well head 660 provides a suspension point for the drill string and pressure seals for casing strings in the well bore.

The blowout preventer (BOP) is a part of the well control system that prevents uncontrolled, and potentially catastrophic release of high-pressure formation fluids (oil, gas, or salt water) from subsea geological formations. These uncontrolled releases of formation fluids are referred to as blowouts. Due to the explosive nature of oil and gas, any spark on the surface may result in the ignition of the fluids and an explosion on the rig.

FIG. 6 shows a Gantt chart illustrating the drilling operations sequence discussed above. The drilling operation includes a sequence of operations carried out at the well centre 16. The sequence of operations is alternating between drilling a well stage and subsequently arranging a casing in the drilled well stage. The illustrate process shows four stages: a surface stage, a first intermediate stage, a second intermediate stage and well completion stage. In the well completion stage, the final part of the bore is drilled at the production casing is placed. For each of the four stages a first step includes drilling the bore and a second step placing a casing in the drilled bore. Only the top level actives have been discussed, but in practice these top level activities will be broken down to a significant number of digital work instructions in the computerized method for performing work-flow drilling operation management for offshore drilling operations according to the invention.

The computerized method for performing work-flow drilling operation management for offshore drilling operations according to the invention provides version control of the digital well plan by which different drafts and versions of the document or record are managed. It is a tool which tracks a series of draft documents, leading to an approved version. The approved version is used for performing the drilling operation, and the approved version is valid until amendments are entered and approved, whereafter the newly approved version is used for performing the drilling operation.

This process with updates and approvals continues until the well drilling have been completed according to the digital work instructions in the computerized method for performing work-flow drilling operation management for offshore drilling operations according to the invention. According to the invention there is provided a tool which tracks a series of earlier approved documents, culminating in a final version. The tool provides an audit trail for the revision and update of these finalised versions.

Version control is important when documents are being created, and for any records that undergo a lot of revision and redrafting. The computerized method for performing work-flow drilling operation management for offshore drilling operations according to the invention provides the latest version of digital well plan providing digital work instructions simultaneously to all stakeholders no matter whether they are responsible for planning, reviewing/authorization, or execution/operation.

The tool is designed to track changes and identify when key decisions were made along the way, as it uses distributed version control.

1. A computerized method for performing work-flow drilling operation management for offshore drilling operations involving a software tool, a planner, one or more reviewers, and a plurality of drilling rig operators, comprising:
a planning phase including:
creating, by the planner, digital work instructions for the offshore drilling operations in the software tool;
sharing, via the software tool, the digital work instructions as draft digital work instructions for the offshore drilling operations with one or more reviewers for approval;
an operation phase including:
creating, in the software tool, an approved version of the digital work instructions when approved by the one or more reviewers;
sharing, via the software tool, the approved version of the digital work instructions with a plurality of drilling rig operators, wherein the plurality of drilling rig operators performs the offshore drilling operations according to the approved version of the digital work instructions; and
reporting, by the drilling rig operators via the software tool, progress of the offshore drilling operations according to the approved version of the digital work instructions;
creating via the software tool a progress report, wherein the planner, the one or more reviewers, and the plurality of drilling rig operators may inspect progress in the work-flow drilling operations relatively to the approved version of the digital work instructions.

2. The method according to claim 1, wherein the software tool in the planning phase invites the planner to specify sensor input offshore drilling operations to be presented in the progress report.

3. The method according to claim 1, wherein the one or more reviewers, via the software tool, in the planning phase may request changes of the draft digital work instructions prior to approval.

4. The method according to claim 1, wherein the software tool upon completion of the digital work instructions is configured to automatically create a report based on data collected from the digital work instructions and the reported progress.

5. The method according to claim 4, wherein the software tool in the planning phase invites the planner to specify sensor input offshore drilling operations to be presented in the progress report, and wherein the report also include the reported sensor data.

6. The method according to claim 1, wherein a part the progress report is represented to drilling rig operators on a monitor on the vessel.

7. The method according to claim 1, wherein the software tool in the operation phase is configured for providing the approved version of the set of digital work instructions used for performing the drilling operation until amendments are introduced into the digital work instructions, and when the introduced amendments are approved, the newly approved digital work instructions are used for performing the drilling operation.

8. The method according to claim 7, wherein the software tool is configured for tracking a series of earlier sets of digital work instructions.

9. The method according to claim 8, wherein the software tool is configured for providing an audit trail for the revision and update of these finalised versions.

10. The method according to claim 1, wherein the software tool is configured for providing the latest version of digital well plan providing digital work instructions simultaneously to all stakeholders no matter whether they are responsible for planning, reviewing/authorization, or execution/operation.

11. The method according to claim 1, wherein the software tool is configured for tracking of changes and identify when key decisions were made along the way, as it uses distributed version control.

12. A non-transitory computer-readable medium storing instructions that when executed by a processor cause the processor to perform work-flow drilling operation management for offshore drilling operations involving a planner, one or more reviewers, and a plurality of drilling rig operators, comprising:
a planning phase including:
creating, by the planner, digital work instructions for the offshore drilling operations;
sharing the digital work instructions as a draft digital work instructions for the offshore drilling operations with one or more reviewers for approval;
an operation phase including:
creating an approved version of the digital work instructions;
sharing the approved version of the digital work instructions with a plurality of drilling rig operators, wherein the plurality of drilling rig operators performs the offshore drilling operations according to the approved version of the digital work instructions; and
reporting progress of the offshore drilling operations according to the approved version of the digital work instructions;
creating a progress report, wherein the planner, the one or more reviewers, and the plurality of drilling rig operators may inspect progress in the work-flow drilling operations relatively to the approved version of the digital work instructions.

13. The computer program product according to claim 12, and being configured to, upon completion of the digital work instructions, automatically create a report based on data collected from the digital work instructions and the reported progress.

14. The computer program product according to claim 13, and being configured to, in the planning phase, invite the planner to specify sensor input offshore drilling operations to be presented in the progress report, and wherein the report also include the reported sensor data.
